(19) United States
(12) Patent Application Publication
(10) Pub. No.: US 2024/0372280 A1
(43) Pub. Date: Nov. 7, 2024

(54) Structure of Universal Serial Bus Connector

(71) Applicant: CHANT SINCERE CO., LTD., New Taipei City (TW)

(72) Inventors: Ming-Hui YEN, New Taipei City (TW); Chun-Wei WU, New Taipei City (TW)

(21) Appl. No.: 18/652,823

(22) Filed: May 2, 2024

(30) Foreign Application Priority Data
May 2, 2023 (TW) 112116333

(51) Int. Cl. H01R 13/02; H01R 24/60

(52) U.S. Cl. CPC H01R 13/02; H01R 24/60

(57) ABSTRACT

An improved structure of a Universal Serial Bus (USB) connector is provided. The improved structure of the USB connector includes: a middle partition, including a base part and a tongue part extending from the base part; an upper row of terminals disposed above the base part, wherein the upper row of terminals have a first contact part having a first width and extending to the tongue part; and a lower row of terminals disposed under the base part, wherein the lower row of terminals have a second contact part having a second width and extending to the tongue part, wherein the tongue part has a third width, and the first width, second width and third width have the same distance.

### CROSS-REFERENCE TO RELATED APPLICATIONS

This application claims the priority benefit of Taiwan Patent Application 112116333, filed on May 2, 2023, the full disclosure of which is incorporated herein by reference.

### TECHNICAL FIELD OF THE INVENTION

The present application is related to a structure of a connector, and is particularly related to an improved structure of a Universal Serial Bus (USB) connector.

### DESCRIPTION OF THE RELATED ART

With developments of technology, various electronic devices have been spread widely, such as mobile phones, tablets, or digital cameras. Different electronic devices can be interconnected through various connectors to perform data transmission. Universal Serial Bus (USB) connector is most widely used among the connectors.

In order to meet requirements of new-generation handheld electronic devices, a completely new design of USB Type-C connector is developed in the existing technology, and one significant feature of the USB Type-C connector is to allow users to insert the USB Type-C connector into another corresponding connector in a positive direction or a negative direction. To achieve the foregoing feature, the USB Type-C connector must include at least 24 terminals, which are divided into an upper row of terminals and a lower row of terminals. The upper row of terminals and the lower row of terminals are arranged symmetrically to fulfill the need for the bidirectional insertion. Additionally, the USB Type-C connector incorporates a conventional baseboard component positioned between the upper row of terminals and the lower row of terminals to reduce occurrence of signal interference between the upper row of terminals and the lower row of terminals.

As disclosed in Taiwan Utility Model Patent Publication No. TWM521814U (hereinafter referred to as the “prior art”), a disclosed electrical connector includes a baseboard component, a first terminal seat, a second terminal seat, a first row of terminals, a second row of terminals, an insulating body, at least one conductive cover plate, and an external shielding body. The first terminal seat and the second terminal seat respectively enclose a portion of the first row of terminals and the second row of terminals, and are combined with the insulating body. The baseboard component is positioned between the first terminal seat and the second terminal seat to prevent static, discharge, or electromagnetic interference between the first row of terminals and the second row of terminals. The insulating body forms multiple terminal channels, each of which is used to accommodate another portion of the first row of terminals and the second row of terminals. The at least one conductive cover plate is disposed on the outer surface of the side wall of the insulating body. The external shielding body is used to encase both the insulating body and the at least one conductive cover plate.

However, in the existing technology, the upper row of terminals is still unable to be entirely separated from the lower row of terminals efficiently by the structural design of the baseboard component, and it causes the USB Type-C connector to be unable to meet specifications and standards for high-frequency characteristics such as Integrated Multi-Reflection (IMR) or Integrated Return Loss (IRL) during high-frequency testing. For example, as described in the prior art, the baseboard component is positioned between the first terminal seat and the second terminal seat, and it still does not meet the requirements for the high-frequency characteristics during high-frequency testing.

Therefore, there is a need to propose a better solution to address the aforementioned high-frequency characteristics issues.

### SUMMARY OF THE INVENTION

Recognizing the shortcomings of the existing technology mentioned above, the main objective of the present application is to provide an improved structure for an USB connector, which merely improves basic components to enhance the performance of the existing serial bus connector in the high-frequency characteristics.

To achieve the abovementioned purpose, the main technical means adopted by the present application lies in that the improved structure of a Universal Serial Bus (USB) connector includes: a middle partition, including a base part and a tongue part extending from the base part; an upper row of terminals disposed above the base part, wherein the upper row of terminals have a first contact part having a first width and extending to the tongue part; and a lower row of terminals disposed under the base part, wherein the lower row of terminals have a second contact part having a second width and extending to the tongue part, wherein the tongue part has a third width, and the first width, second width and third width have the same distance.

Through the abovementioned structure, the middle partition is positioned between the upper row of terminals and the lower row of terminals, and the first width of the first contact part of the upper row of terminals, the second width of the second contact part of the lower row of terminals, and the third width of the tongue part are the same width, and the first contact part of the upper row of terminals, the second contact part of the lower row of terminals and the tongue part are in a state of a structure with the same width as each other. By the improvement of the abovementioned structure, the purpose of enhancing the performance of the connector in the present application in the high-frequency characteristics is achieved.

### BRIEF DESCRIPTION OF DRAWINGS

FIG. 1 is a front view of an embodiment of the improved structure of the universal serial bus connector of the present invention.

FIG. 2 is a side view of an embodiment of the improved structure of the universal serial bus connector of the present invention.

FIG. 3 is a three-dimensional view of an embodiment of the improved structure of the universal serial bus connector of the present invention.

FIG. 4 is a left side view of an embodiment of the improved structure of the universal serial bus connector of the present invention.

### DETAILED DESCRIPTION OF THE INVENTION

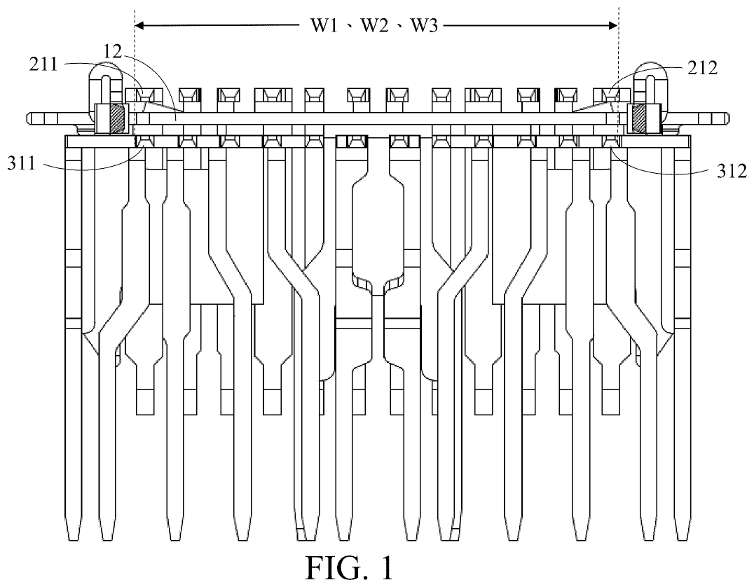

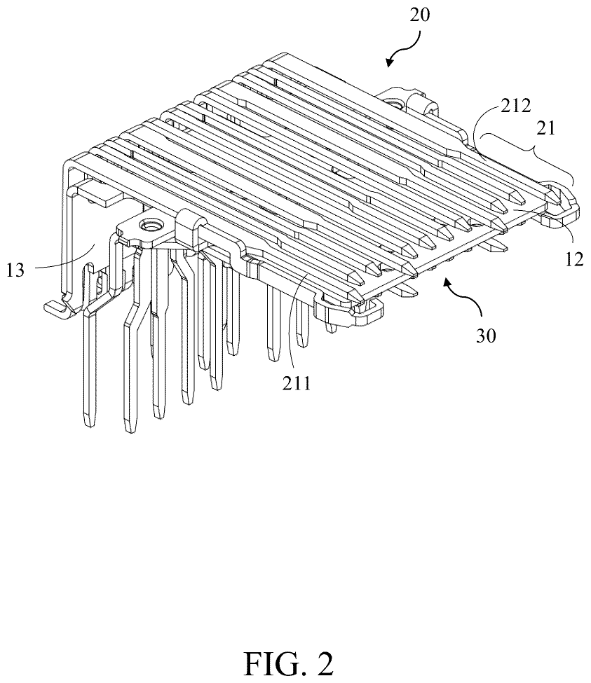

Regarding the embodiment of the improved structure of the USB connector in the present application, please refer to FIG. 1 to FIG. 3. The improved structure of the universal serial bus connector includes a middle partition 10, an upper row of terminals 20 and a lower row of terminals 30, the middle partition 10 includes a base part 11 and a tongue part 12, and the tongue part 12 extends from the base part 11 toward the front end. The middle partition 10 is disposed between the upper row of terminals 20 and the lower row of terminals 30, the upper row of terminals 20 is disposed above the base part 11, and the upper row of terminals 20 has a first contact part 21, and the first contact part 21 extends to the tongue part 12. The lower row of terminals 30 is disposed under the base part 11, and the lower row of terminals 30 has a second contact part 31, and the second contact part 31 extends to the tongue part 12. In this embodiment, as shown in FIG. 1, the first contact part 21 of the upper row of terminals 20 has a first width W1 in the horizontal direction, the second contact part 31 of the lower row of terminals 30 has a second width W2 in the horizontal direction, and the tongue part 12 has a third width W3, the first width W1 of the first contact part 21 of the upper row of terminals 20, the second width W2 of the second contact part 31 of the lower row of terminals 30 and the third width W3 of the tongue part 12 are the same width, and the first contact part 21 of the upper row of terminals 20, the second contact part 31 of the lower row of terminals 30 and the tongue part 12 are in a state of a structure with the same width as each other. Therefore, through the improvement and special design of the upper row of terminals 20, the lower row of terminals 30 and the tongue part 12 of the middle partition 10, the performance of the serial bus connector of the present application in the high-frequency characteristics can be enhanced.

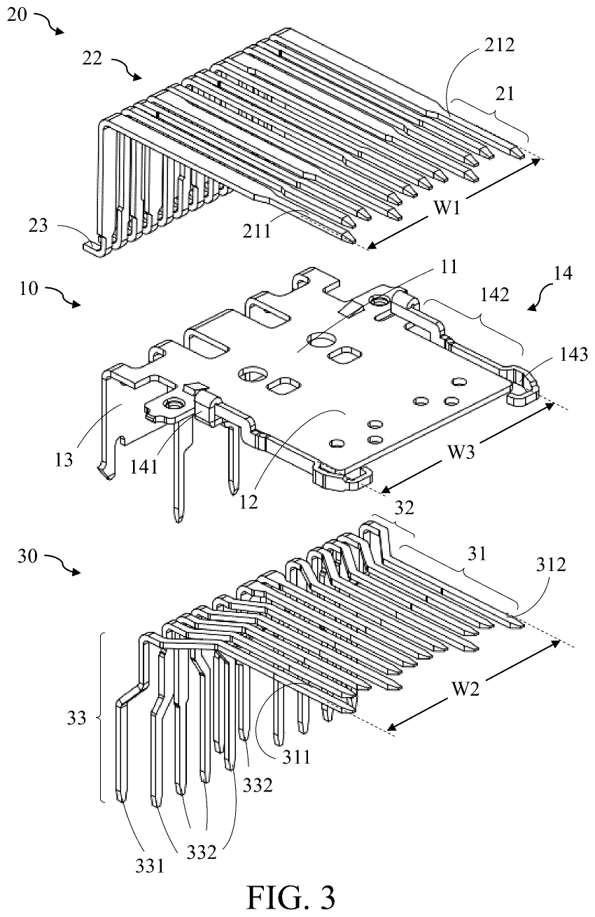

In this embodiment, the middle partition 10 further includes a rear wall 13, the position of the rear wall 13 is corresponding to the position of the tongue part 12, and the rear wall 13 faces downward and extends perpendicularly from one end of the base part 11 away from the tongue part 12. As shown in FIGS. 1 and 3, in this embodiment, the first contact part 21 of the first contact part 21 has a first contact end 211 and a second contact end 212, and the position of the first contact end 211 and the position of the second contact end 212 are opposite in the left direction and the right direction of the first contact part 21. The first contact end 211 is arranged at the leftest position in the horizontal direction of the first contact part 21, the second contact end 212 is arranged at the rightest position in the horizontal direction of the first contact part 21, and the first width W1 of the first contact part 21 indicates the distance between the outer wall of the first contact end 211 and the outer wall of the second contact end 212. The second contact part 31 of the lower row of terminals 30 has a third contact end 311 and a fourth contact end 312, the third contact end 311 is arranged at the most left position in the horizontal direction of the second contact part 31, the fourth contact end 312 is arranged at the most right position in the horizontal direction of the second contact part 31, and the second width W2 of the second contact part 31 indicates the distance between the outer wall of the third contact end 311 and the outer wall of the fourth contact end 312. The third width W3 of the tongue part 12 indicates the distance between the two relative sidewalls of the tongue part 12. In this embodiment, the third width W3 equals to the first width W1 and the second width W2, the improved structure of the tongue part 12 can effectively reinforce the isolation of the upper row of terminals 20 and the lower row of terminals 30 to enhance the effects of preventing the static, the discharge or the electromagnetic interference between the upper row of terminals 20 and the lower row of terminals 30, and thus, the USB connector in the present application has the better effects of transmitting the high-frequency signal.

Furthermore, in this embodiment, the middle partition 10 further includes two spring arms 14 in an opposite arrangement. Please refer to FIG. 3, and the two spring arms 14 extend to the direction of the first contact part 21 of the upper row of terminals 20, and each of the two spring arms 14 respectively includes a turnover part 141, a protecting part 142 and a protecting plate 143. The turnover part 141 is disposed on one end of the spring arm 14, and each of the turnover parts 141 is respectively shaped like the letter “C”, and the bottom end of each of the turnover parts 141 respectively connects to the left side and the right side of the base part 11 of the middle partition 10, and the protecting parts 142 is formed by extending the top end of each of the turnover parts 141 to the front end of the tongue part 12 to protect the two sidewalls of the tongue part 12. The front ends of the protecting parts 142 further respectively extend to form the protecting plates 143 to protect the two sides of the front end of the tongue part 12. In this embodiment, because the turnover parts 141 are the perpendicular C-shaped structures, a larger isolated space may be formed between the upper row of terminals 20 and the lower row of terminals 30 by the turnover parts 141 to further prevent the signal interference between the upper row of terminals 20 and the lower row of terminals 30, and the protecting parts 142 and the protecting plates 143 can protect the tongue part 12 so that the tongue part 12 is less prone to be wore out to influence its use during interconnection.

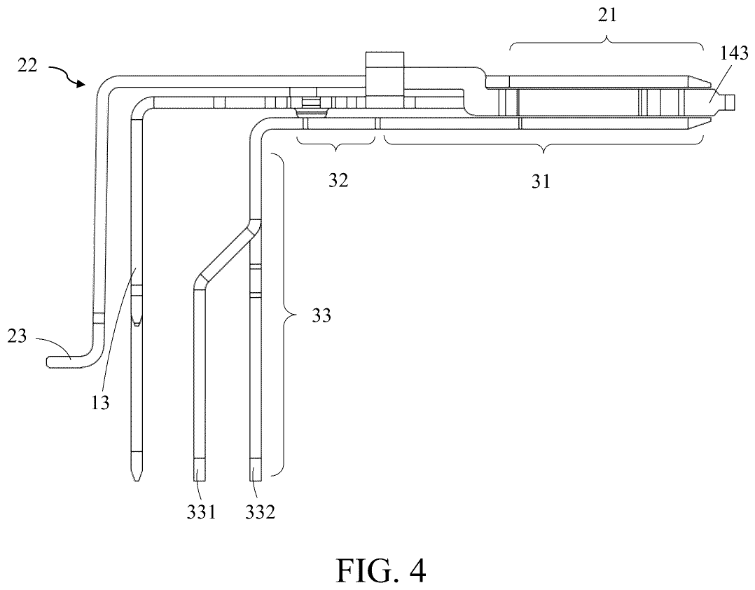

Furthermore, please refer to FIG. 3 and FIG. 4, in this embodiment, the upper row of terminals 20 further includes a set of strengthen parts 22 and a set of welding parts 23, the first contact part 21 is formed by extending the front end of the set of strengthen parts 22, and the set of welding parts 23 are formed by extending and downward bending the back end of the set of strengthen parts 22. The first contact part 21 is used to electrically connect to an external connector (not shown), and the set of welding parts 23 is used to connect to a printed circuit (not shown). In this embodiment, the amount of the set of strengthen parts 22 is multiple, the first contact part 21 is constituted of multiple first contact subparts, and the widths of at least two strengthen parts 22 are longer than that of the first contact subpart. In this embodiment, the positions of the at least two strengthen parts 22 are respectively corresponding to the first contact end 211 and the second contact end 212 of the first contact part 21.

Please refer to FIG. 3, in this embodiment, the lower row of terminals 30 further includes a set of bent parts 32 and a set of pin parts 33, wherein the second contact part 31 is formed by extending the front end of the set of bent parts 32, and the set of pin parts 33 are formed by vertically extending the back end of the set of bent parts 32 in a downward direction, and each pin of the set of pin parts 33 has a wider spacing to reduce the signal interference between each pin. Please refer to FIG. 4, the set of pin parts 33 includes multiple first pins 331 and multiple second pins 332, the multiple first pins 331 and the multiple second pins 332 are arranged in an interlaced configuration to further increase the spacing between the individual pins.

1. An improved structure of a Universal Serial Bus (USB) connector, comprising:
a middle partition, comprising a base part and a tongue part extending from the base part;
an upper row of terminals disposed above the base part, wherein the upper row of terminals have a first contact part having a first width and extending to the tongue part; and
a lower row of terminals disposed under the base part, wherein the lower row of terminals have a second contact part having a second width and extending to the tongue part,
wherein the tongue part has a third width, and the first width, second width and third width have the same distance.

2. The improved structure of the USB connector as claimed in claim 1, wherein the upper row of terminals comprises a set of strengthen parts and a set of welding parts, the set of strengthen parts has a front end and a back end, the first contact part is formed by extending the front end of the set of strengthen parts, the set of welding parts is formed by extending the back end of the set of strengthen parts, and at least two strengthen parts have respective width greater than a width of the respective first contact part.

3. The improved structure of the USB connector as claimed in claim 1, wherein the first contact part of the upper row of terminals comprises a first contact end and a second contact end, a position of the first contact end and a position of the second contact end are opposite in a left direction and a right direction of the first contact part, and the first width of the first contact part is a distance between the first contact end and the second contact end.

4. The improved structure of the USB connector as claimed in claim 1, wherein the second contact part of the lower row of terminals comprises a third contact end and a fourth contact end, a position of the third contact end and a position of the fourth contact end are opposite in a left direction and a right direction of the second contact part, and the second width of the second contact part is a distance between the third contact end and the fourth contact end.

5. The improved structure of the USB connector as claimed in claim 1, wherein the third width of the tongue part is a distance between two sides of the tongue part.

6. The improved structure of the USB connector as claimed in claim 1, wherein the upper row of terminals comprise a set of strengthen parts and a set of welding parts, the set of strengthen parts has a front end and a back end, the first contact part is formed by extending the front end of the set of strengthen parts, and the set of welding parts is formed by extending and downward bending the back end of the set of strengthen parts.

7. The improved structure of the USB connector as claimed in claim 1, wherein the lower row of terminals comprise a set of bent parts and a set of pin parts, the set of bent parts has a front end and a back end, the second contact part is formed by extending the front end of the set of bent parts, the set of pin parts is formed by vertically extending the back end of the set of bent parts in a downward direction, and each pin of the set of pin parts is arranged in an interlaced configuration.

8. The improved structure of the USB connector as claimed in claim 1, wherein the middle partition further comprises two spring arms in an opposite arrangement, the two spring arms extend toward a direction of the first contact part of the upper row of terminals.

9. The improved structure of the USB connector as claimed in claim 8, wherein each of the two spring arms has a turnover part and a protecting part, the turnover part is disposed on one end of each of the two spring arms, a bottom end of each spring arm respectively connects to a left side and a right side of the base part of the middle partition, and the protecting part is formed by extending a top end of each spring arm to a front end of the tongue part.

10. The improved structure of the USB connector as claimed in claim 9, wherein each spring arm respectively comprises a protecting plate, and the protecting plate is formed by extending a front end of the protecting part.
